(19) United States
(12) Patent Application Publication
(10) Pub. No.: US 2022/0391710 A1
(43) Pub. Date: Dec. 8, 2022

(54) NEURAL NETWORK BASED POWER AND PERFORMANCE MODEL FOR VERSATILE PROCESSING UNITS

(71) Applicant: Intel Corporation, Santa Clara, CA (US)

(72) Inventors: Alessandro Palla, Pisa (IT); Ian Frederick Hunter, Carnaross (IE); Richard Richmond, Belfast (GB); Cormac Brick, San Francisco, CA (US); Sebastian Eusebiu Nagy, Ineu Arad (RO)

(73) Assignee: Intel Corporation, Santa Clara, CA (US)

(21) Appl. No.: 17/820,593

(22) Filed: Aug. 18, 2022

Related U.S. Application Data
(60) Provisional application No. 63/326,412, filed on Apr. 1, 2022.

(51) Int. Cl. G06N 3/10; G06N 3/08

(52) U.S. Cl. CPC G06N 3/10; G06N 3/08

(57) ABSTRACT

Systems, apparatuses and methods may provide for technology that determines a complexity of a task associated with a neural network workload and generates a hardware efficiency estimate for the task, wherein the hardware efficiency estimate is generated via a neural network based cost model if the complexity exceeds a threshold, and wherein the hardware efficiency estimate is generated via a cost function if the complexity does not exceed the threshold. In one example, the technology trains the neural network based cost model based on one or more of hardware profile data or register-transfer level (RTL) data.

### CROSS-REFERENCE TO RELATED APPLICATIONS

This patent application claims the benefit of priority to U.S. Provisional Patent Application No. 63/326,412, filed on Apr. 1, 2022.

### TECHNICAL FIELD

Embodiments generally relate to neural networks. More particularly, embodiments relate to a neural network based power and performance model for versatile processing units (VPUs).

### BACKGROUND

A PnP (Power and Performance) model is a software component that predicts the performance (e.g., in terms of clock cycles) and power consumption (e.g., in milliWatts/mW) for a given neural network workload/layer. Conventional solutions to performing PnP predictions may encounter challenges in terms of complexity, scalability and/or stability.

### BRIEF DESCRIPTION OF THE DRAWINGS

The various advantages of the embodiments will become apparent to one skilled in the art by reading the following specification and appended claims, and by referencing the following drawings, in which:

FIG. 1 is a chart of an example of effective operations versus the number of input channels and output channels according to an embodiment;

FIGS. 2A and 2B are comparative plots of examples of prediction error and profiled cost for conventional solutions and ground truths;

FIG. 3 is an illustration of an example of a conventional iteration cycle to update a feature;

FIG. 4 is an illustration of an example of a cost function and a neural network based cost model according to an embodiment;

FIG. 5 is an illustration of an example of sources of data for a training database and an associated application programming interface (API) according to an embodiment;

FIG. 6 is an illustration of an example of a latency optimized neural network and an accuracy optimized neural network according to embodiments;

FIG. 7 is a flowchart of an example of a method of managing hardware according to an embodiment;

FIG. 8 is a comparative plot of cost modeling over a range of configurations according to an embodiment;

FIG. 9 is a chart of an example of network performance improvement for a compiler scheduler according to an embodiment;

FIG. 10 is a comparative set of plots showing conventional mean average percentage error (MAPE) and MAPE according to an embodiment;

FIG. 11 is a block diagram of an example of a performance-enhanced computing system according to an embodiment;

FIG. 12 is an illustration of an example of a semiconductor package apparatus according to an embodiment;

FIG. 13 is a block diagram of an example of a processor according to an embodiment; and

FIG. 14 is a block diagram of an example of a multi-processor based computing system according to an embodiment.

### DESCRIPTION OF EMBODIMENTS

Technology described herein provides an innovative, data driven way of improving PnP prediction of workloads for VPUs (versatile processing units) that are integrated into SoCs (systems on chip).

Having an accurate PnP model is advantageous across the entire software stack, since model accuracy enables increased accuracy of pre-silicon network PnP KPI (key performance indicator) estimations and improved performance of neural networks on the device (e.g., providing the compiler scheduler with an accurate PnP model to correctly understand the consequences of scheduling decisions). An accurate PnP model also enables operating system (OS)-based dynamic voltage and frequency scaling (DVFS) optimization. For example, the cost model can be used to decide whether to throttle the VPU voltage and/or frequency to reduce dynamic power consumption. Additionally, an accurate PnP enables network architecture search (NAS) decisions to use machine learning to train a neural network topology alongside the weights of the neural network. Indeed, an accurate cost model in combination with NAS allows enables the creation of networks that are highly tailored and optimized for the VPU hardware.

Previous solutions to predicting power and performance may have used an equation-based solution such as, for example, ArchBench, to perform PnP predictions for KPI estimation. ArchBench is a tool that encodes the hardware performance into a set of simple equations. These equations can be used to estimate the performance of each workload/layer and summed in order to recover the entire network performance. Since ArchBench is not production-grade software, compiler and OS integration have previously not been possible.

Three main disadvantages to the previous equation-driven approach are:

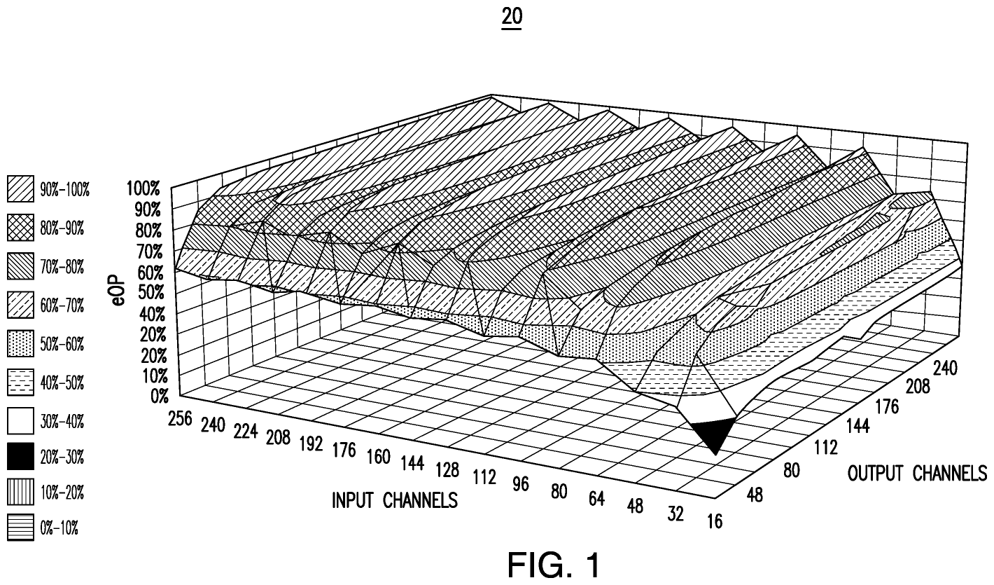

Complexity: FIG. 1 shows a chart 20 a profile of effective operations (eOPs) for a 1×1s1 (e.g., max pooling 1×1 with stride 1) convolution kernel with a varying number of input channels and output channels. The hardware efficiency (Z axis) varies with the dimensions of the channel and diverges from the theoretical calculation. This effect is especially significant for a small number of input and output channels. The chart 20 therefore demonstrates the highly nonlinear hardware behavior. As a result, the hardware behavior is too complex to be synthetized into a set of simple equations. Moreover, intimate hardware knowledge may be required to write the equations and second order effects are difficult to model. These complexity challenges become significant in certain corners of the configuration space.

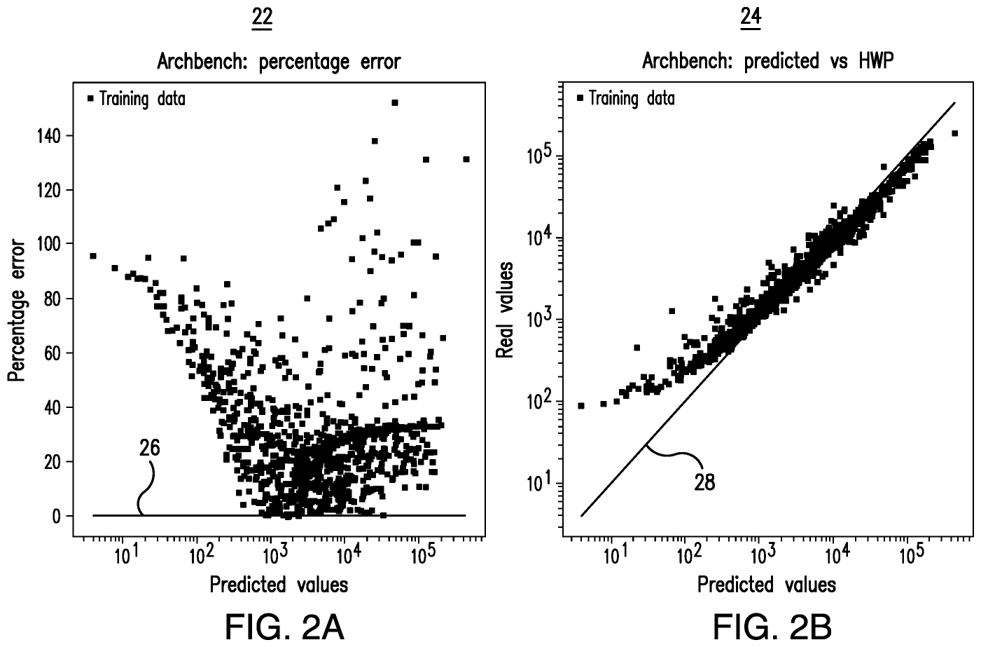

This effect can be seen further in FIGS. 2A and 2B, where a plot 22 compares the scale of prediction error (Y axis) to the predicted cost of the workloads (X axis) and a plot 24 compares the profiled cost (Y axis) to the predicted cost of the workloads (X axis). Second order effects cause the accuracy of the plot 22 to diverge from a ground truth 26 and the accuracy of the plot 24 to diverge from a ground truth 28. Inefficiencies in modelling second order effects have accumulated for small workloads, making the ArchBench model consistently overestimate performance.

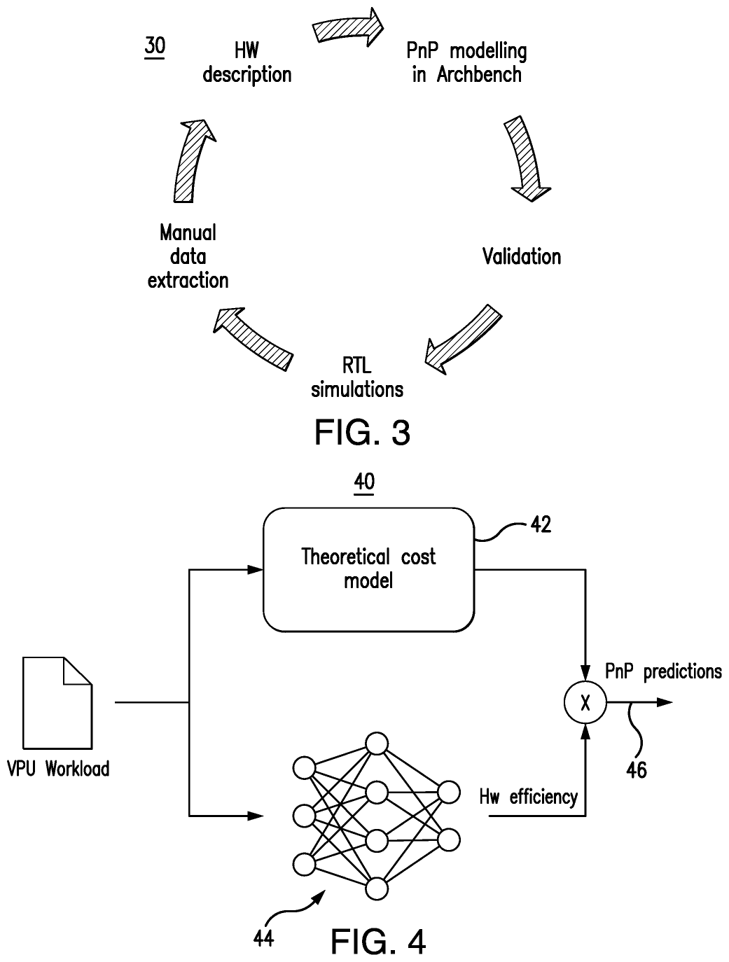

Scalability: FIG. 3 demonstrates that the complexity of the conventional model may require a considerable amount of engineering time for development and maintenance. More particularly, an update process 30 is long and tedious, requiring manual fine-tuning of multiple model parameters, regression management, validation, simulations and so forth. As a result, the update process 30 may take up to several weeks or even months for every new update to the model. Still, because of the complexity of the hardware, an acceptable level of accuracy for many workloads has never been achieved, meaning that it has not been possible to scale this approach in the past.

Stability: It may also not be possible to leverage the existing PnP model in production directly, because of code compatibility (e.g., ArchBench is written in PYTHON, while the compiler/OS driver may require C++), scope (e.g., ArchBench is mostly a tool for early stage “what if” analysis) and performance estimation. Accordingly, the findings and knowledge that the engineers feed into this tool are not usable immediately by other individuals.

Technology described herein provides for “VPUNN” (Neural Network Based Power and Performance Model for VPUs), which is a data driven PnP model where a neural network is trained with real world performance data from the VPU to have higher accuracy than conventional solutions. The model is accurate, fast, straightforward to update from new workloads and can be used and deployed at all levels of the software stack.

The accuracy of performance prediction is much higher than previous solutions, providing realistically achievable targets for products at a much earlier stage than before. The major advantages (e.g., business impacts) of the technology described herein are enablement of high-confidence performance estimates for more networks in a pre-silicon timeframe, improving accuracy of (e.g., KPI estimates), and assistance in closing the gap between pre-silicon and post-silicon performance estimates. Other advantages of the technology include enablement of quick insights of the performance of new network topologies and enablement of advanced compiler schedule optimizations, which further increase the performance of neural networks. Indeed, the technology described herein enables optimizations in different areas such as, for example, optimizing power usage instead of performance and restricting power to within an allowed envelope.

Embodiments include a software library capable of predicting the PnP of individual workloads and layers of a network. The core of the library is a neural network that is trained from real world data profiled directly from the hardware or from RTL (register-transfer level) simulations.

FIG. 4 shows a VPUNN model 40 that includes a basic algorithmic cost function 42 (e.g., theoretical/simple cost model) to model simple tasks and a neural network based cost model 44 to model complex tasks. Together, the two create a prediction of the hardware efficiency, wherein the outputs of each are combined to obtain final overall predictions 46 of the network performance. The model 40 addresses the aforementioned challenges as follows:

Complexity

The algorithmic cost function 42 is much simpler than what is implanted in ArchBench and does not consider second order effects or nonlinearities. Additionally, the complexity and the nonlinear hardware behavior are trained from real HWP (hardware profiler) data into the weights of the neural network and does not require manual finetuning. Moreover, the PnP model can be inspected to understand details of the hardware behavior and examine shortcomings between theoretical calculations and actual results.

Scalability

Adding new workloads to the database is comparatively easier than having engineers fixing the cost model manually. In addition, the training process is fully automatic, with the neural network being trained, for example, nightly with the latest items profiled from the hardware.

Portability

The model 40 can be deployed and used by all tools/compilers/drivers at various levels of the stack. In one example, a neural network compiler targeting a VPU workload can use the model 40 and be immediately up to speed.

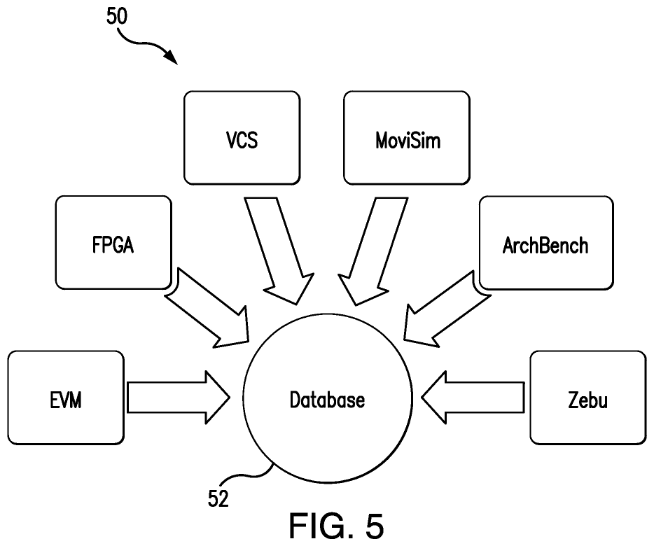

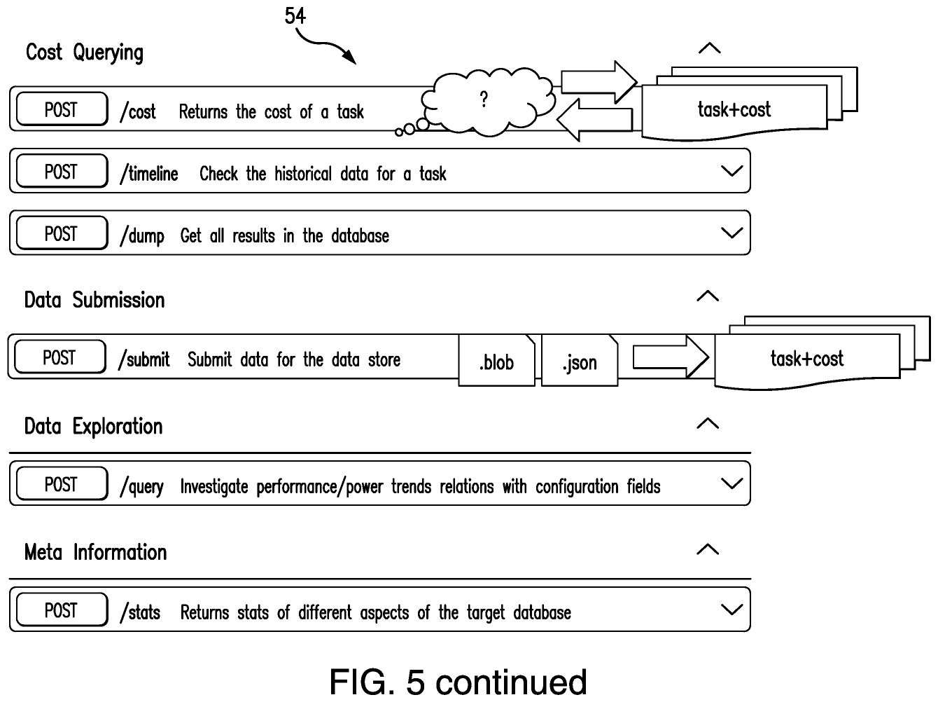

FIG. 5 shows data sources 50 that populate a training database 52 and an API 54 to retrieve information from the training database 52. To train the neural network, a large data set of different task configurations is executed and profiled from hardware or, if early in development, emulation platforms. The performance metric as well as the configuration information is recorded in the training database 52. The API 54 may include a set of REST (Representational State Transfer) APIs for access to the profiled data (e.g., by individuals in the entire organization).

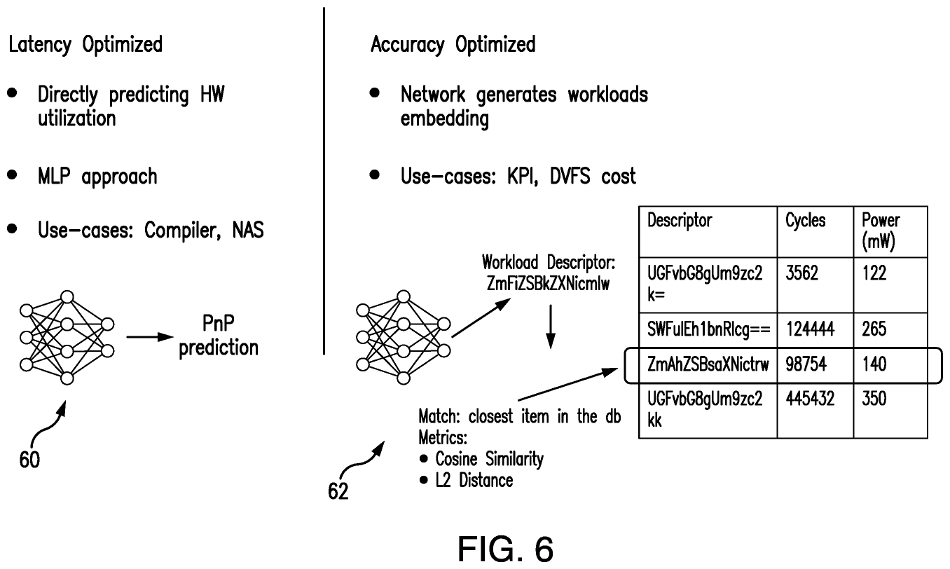

FIG. 6 demonstrates that the neural network based cost model can be deployed in two different variants 60, 62. A first variant 60 is a latency optimized version in which the model directly predicts the hardware utilization and is optimized for latency and speed. The result is a fast yet accurate model that can be integrated into products that call for high performance such as, for example, a neural network compiler or an OS driver. The first variant 60 is also suitable for components that call the model many times such as, for example, an NAS component.

A second variant 62 is an accuracy optimized version in which the model generates a workload embedding/descriptor. An embedding is an N-dimensional vector that represents/maps the workload into an abstract embedding space. The embedding representation of a workload can be used to fetch and interpolate the closest items in the database using, for example, cosine similarity or L2 distance (e.g., calculated as the square root of the sum of squared vector values). This approach is more accurate, but the performance grows linearly with the size of the database. Accordingly, the second variant 62 may be better suited for KPI estimation and DVFS scenarios that have less stringent requirements in terms of prediction latency.

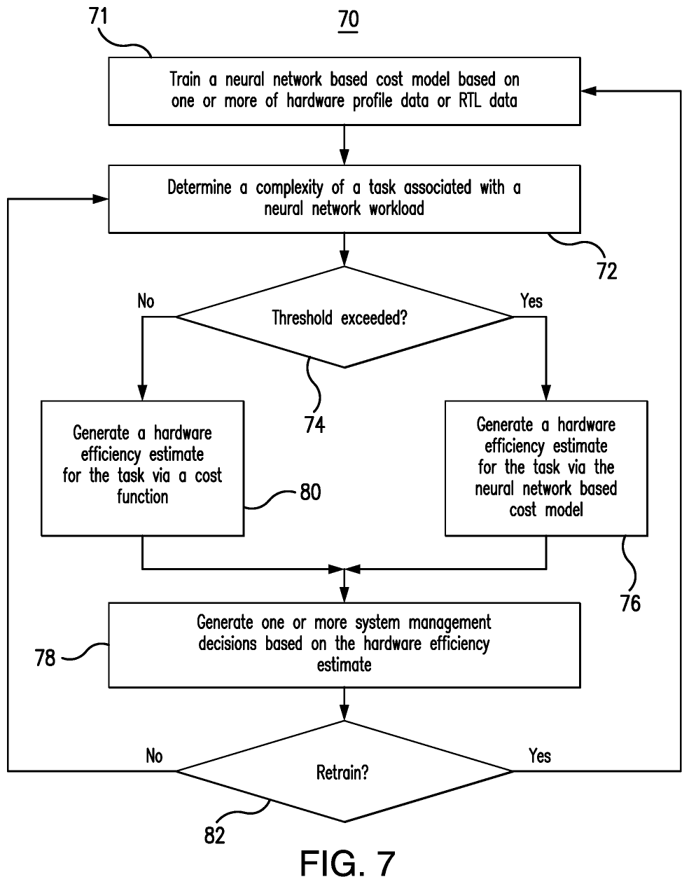

FIG. 7 shows a method 70 of managing hardware. The method 70 may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 70 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 71 provides for training a neural network based cost model based on one or more of hardware profile data or register-transfer level (RTL) data. Block 72 determines a complexity of a task associated with a neural network workload (e.g., VPU workload). A determination is made at block 74 as to whether the complexity of the task exceeds a threshold. If so, block 76 generates a hardware efficiency estimate for the task via the neural network based cost model. As already noted, the neural network based cost model may be accuracy optimized or latency optimized. When the neural network based cost model is accuracy optimized, the hardware efficiency estimate may include a vector that embeds the task into an abstract embedding space. In such a case, block 76 may also fetch a database entry based on the vector. When the neural network based cost model is latency optimized, the hardware efficiency estimate may include a hardware utilization prediction.

Block 78 may generate one or more system management decisions based on the hardware efficiency estimate. For example, if the neural network based cost model is accuracy optimized, block 78 might involve generating one or more of a DVFS decision (e.g., throttle decision) and/or a KPI decision (e.g., mean time to resolve/MTTR decision) based on the hardware efficiency estimate. If, on the other hand, the network based cost model is latency optimized, block 78 may generate a compiler decision (e.g., scheduling decision), a driver decision (e.g., component enablement/disablement decision) and/or an NAS decision (e.g., topology selection) based on the hardware efficiency estimate.

If it is determined at block 74 that the complexity of the task does not exceed the threshold, block 80 generates the hardware efficiency estimate via a cost function (e.g., theoretical/simple cost model). In an embodiment, the cost function generates the hardware efficiency estimate independently of second order effects and nonlinearities associated with the task. As already noted, block 78 may generate one or more system management decisions based on the hardware efficiency estimate. Block 82 determines whether a retraining of the neural network based cost model is appropriate (e.g., periodic retraining, switch between latency optimized and accuracy optimized, etc.). If so, the method 70 returns to block 71. Otherwise, the method 70 may return to block 72 for the next task in the neural network workload. The method 70 therefore enhances performance at least to the extent that the cost function reduces complexity for relatively simple tasks, the neural network based cost model improves scalability for more complex tasks and/or the hybrid model improves portability.

Results:

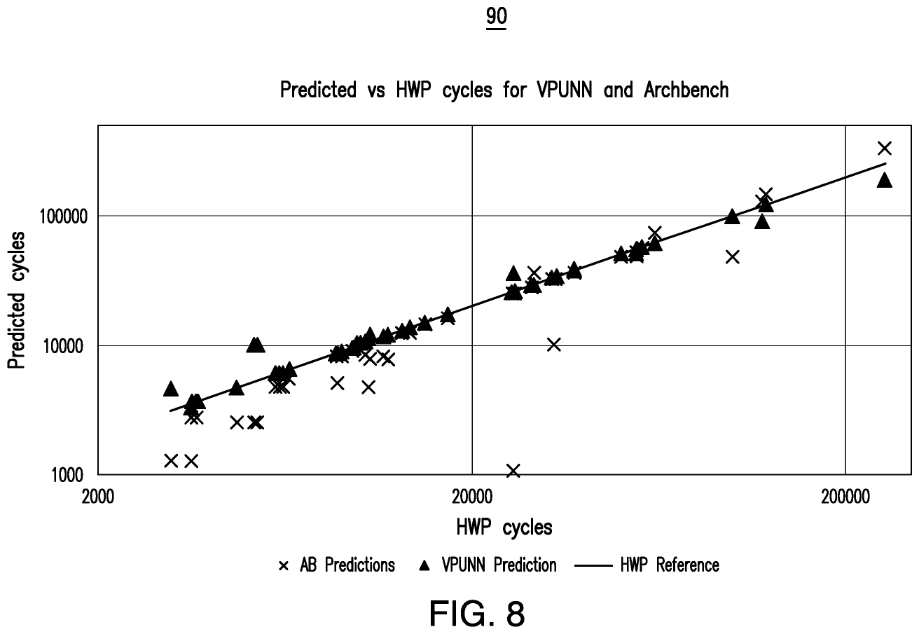

FIG. 8 shows a plot 90 that compares cost modelling over a range of configurations. Table I below shows a comparison of accuracy rates and execution times. In the illustrated example, ResNet-50 was recorded to be better at estimating the FPGA frames per second (FPS), but this recording may be misleading as positive and negative errors for each task cancel one another out.

TABLE 1

| | ArchBench | VPUNN | VPUNN |
|---|---|---|---|
| | Estimate | Estimate | Execution Time |
| Network | [FPS] | [FPS] | Speedup [s] |
| ResNet-50 | 2% | 3% | 28.9x |
| MobileNet v2 | 35% | 6% | 65.9x |
| Yolo Tiny v2 | −10% | 2% | 47.8x |

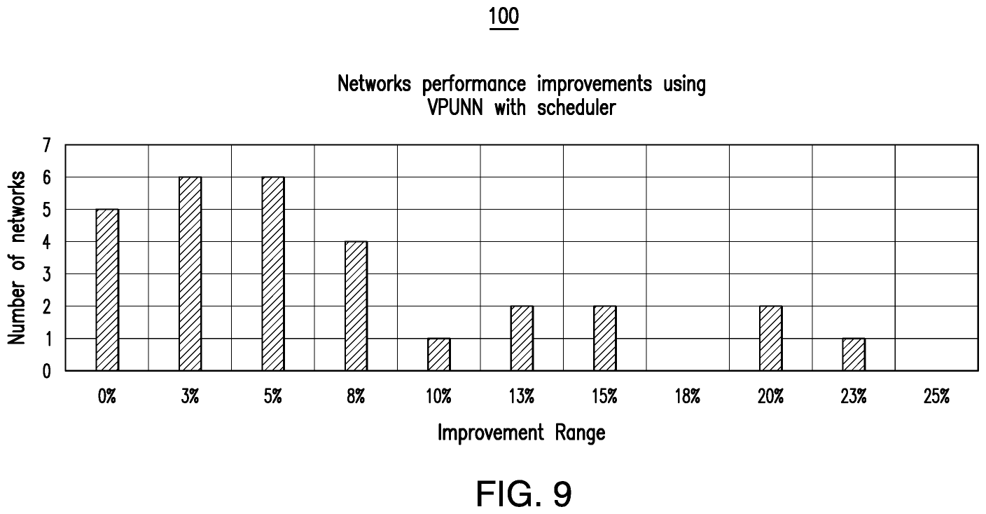

FIG. 9 shows a chart 100 of network performance improvement with a VPUNN cost model being incorporated into (e.g., tailored to) a compiler scheduler.

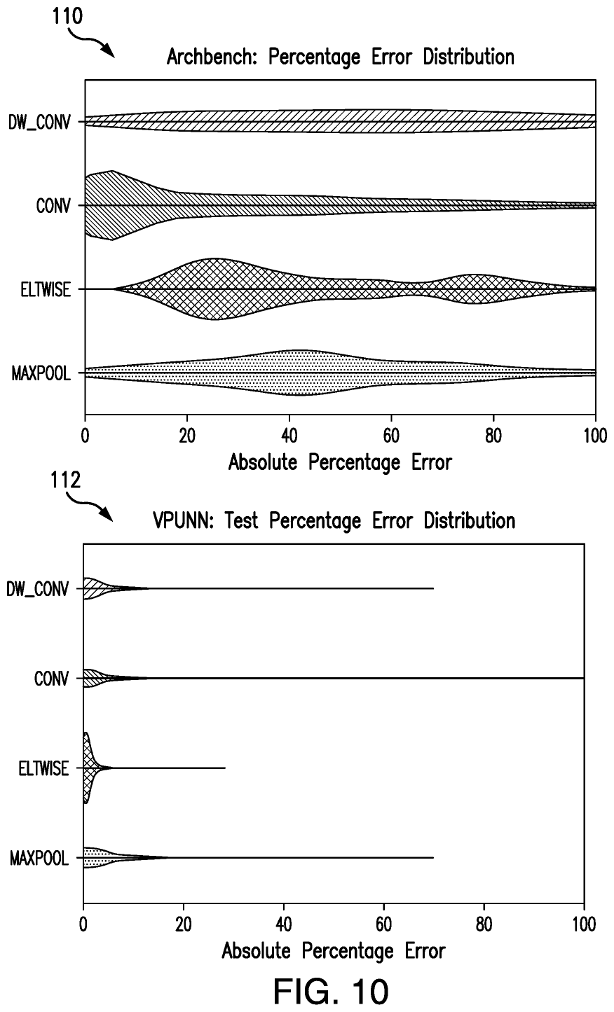

FIG. 10 shows a conventional plot 110 of mean average percentage error (MAPE, e.g., when compared to FPGA results) and an enhanced plot 112 of MAPE (e.g., also compared to FPGA results).

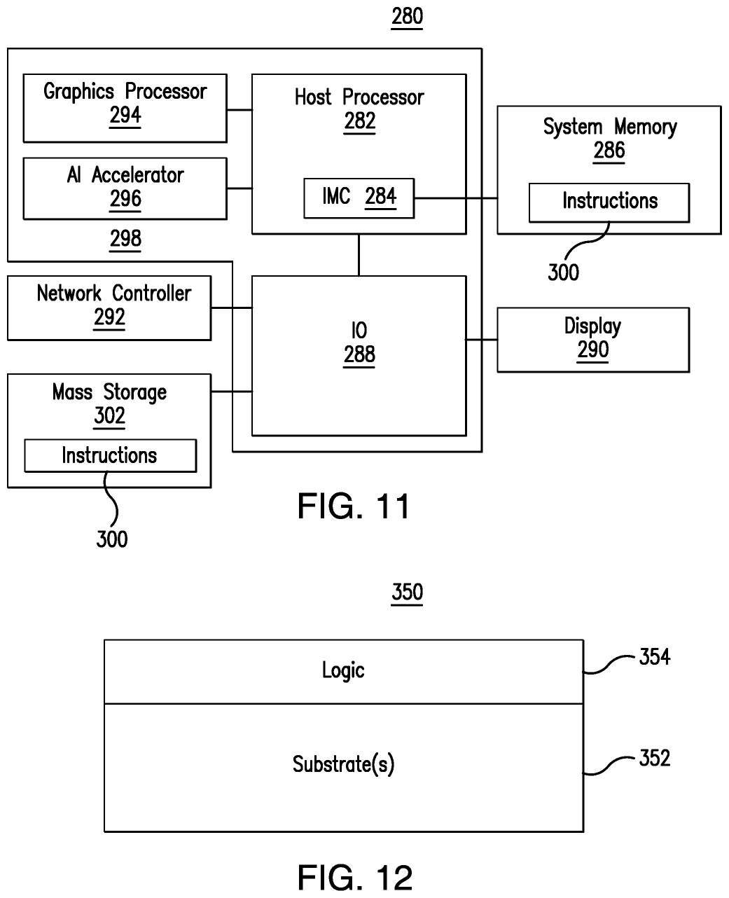

Turning now to FIG. 11, a performance-enhanced computing system 280 is shown. The system 280 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 280 includes a host processor 282 (e.g., CPU) having an integrated memory controller (IMC) 284 that is coupled to a system memory 286 (e.g., dual inline memory module/DIMM). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/I-EDD, optical disc, solid state drive/SSD) and a network controller 292 (e.g., wired and/or wireless). The host processor 282 may be combined with the IO module 288, a graphics processor 294, and an artificial intelligence (AI) accelerator 296 into a system on chip (SoC) 298.

In an embodiment, the host processor 282 and/or the AI accelerator 296 executes a set of program instructions 300 retrieved from the mass storage 302 and/or the system memory 286 to perform one or more aspects of the method 70 (FIG. 7), already discussed. Thus, execution of the illustrated instructions 300 by the host processor 282 and/or the AI accelerator 296 causes the host processor 282 and/or the AI accelerator 296 to determine a complexity of a task associated with a neural network workload and generate a hardware efficiency estimate for the task, wherein the hardware efficiency estimate is generated via a neural network based cost model if the complexity exceeds a threshold, and wherein the hardware efficiency estimate is generated via a cost function if the complexity does not exceed the threshold. The computing-system 280 is therefore performance-enhanced at least to the extent that the cost function reduces complexity for relatively simple tasks, the neural network based cost model improves scalability for more complex tasks and/or the hybrid model improves portability.

FIG. 12 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 70 (FIG. 7), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

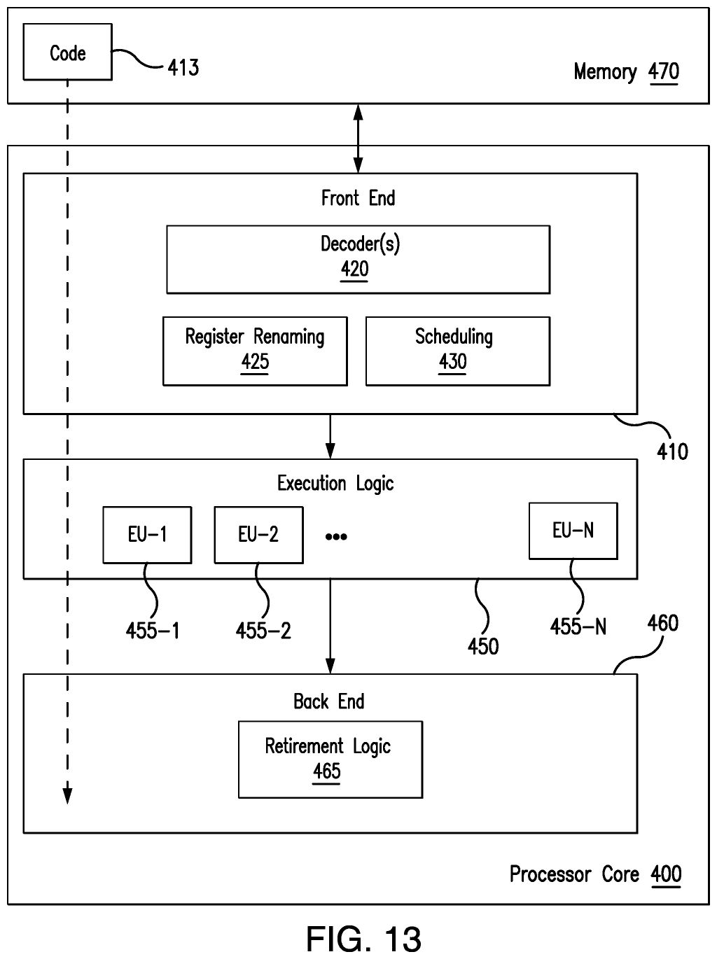

FIG. 13 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 13, a processing element may alternatively include more than one of the processor core 400 illustrated in FIG. 13. The processor core 400 may be a single-threaded core or, for at least one embodiment, the processor core 400 may be multithreaded in that it may include more than one hardware thread context (or “logical processor”) per core.

FIG. 13 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 70 (FIG. 7), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 13, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

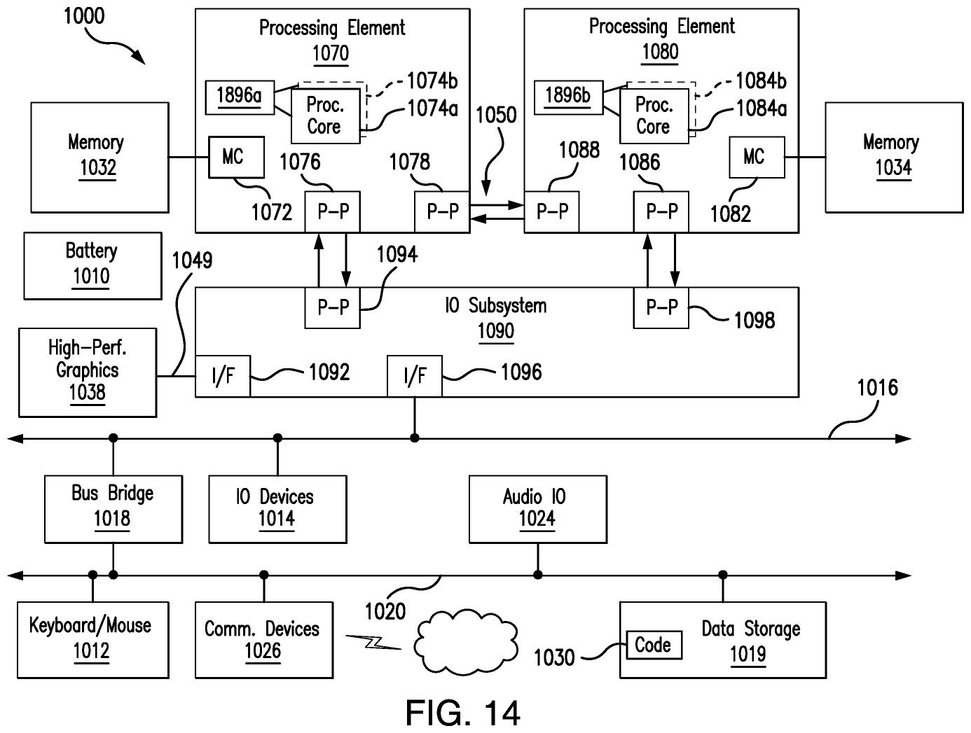

Referring now to FIG. 14, shown is a block diagram of a computing system 1000 embodiment in accordance with an embodiment. Shown in FIG. 14 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 14 may be implemented as a multi-drop bus rather than point-to-point interconnect.

As shown in FIG. 14, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 13.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 14, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 14, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 14, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 70 (FIG. 7), already discussed. Further, an audio I/O 1024 may be coupled to second bus 1020 and a battery 1010 may supply power to the computing system 1000.

Note that other embodiments are contemplated. For example, instead of the point-to-point architecture of FIG. 14, a system may implement a multi-drop bus or another such communication topology. Also, the elements of FIG. 14 may alternatively be partitioned using more or fewer integrated chips than shown in FIG. 14.

### ADDITIONAL NOTES AND EXAMPLES

Example 1 includes a performance-enhanced computing system comprising a network controller, a processor coupled to the network controller, and a memory coupled to the processor, the memory including a set of instructions, which when executed by the processor, cause the processor to determine a complexity of a task associated with a neural network workload and generate a hardware efficiency estimate for the task, wherein the hardware efficiency estimate is generated via a neural network if the complexity exceeds a threshold, and wherein the hardware efficiency estimate is generated via a cost function if the complexity does not exceed the threshold.

Example 2 includes the computing system of Example 1, wherein the instructions, when executed, further cause the processor to train the neural network based cost model based on one or more of hardware profile data or register-transfer level data.

Example 3 includes the computing system of any one of Examples 1 to 2, wherein the neural network based cost model is to be accuracy optimized, wherein the hardware efficiency estimate is to include a vector that embeds the task into an abstract embedding space, and wherein the instructions, when executed, further cause the processor to fetch a database entry based on the vector.

Example 4 includes the computing system of Example 3, wherein the instructions, when executed, further cause the processor to generate one or more of a dynamic voltage and frequency scaling decision or a key performance indicator decision based on the hardware efficiency estimate.

Example 5 includes the computing system of any one of Examples 1 to 2, wherein the neural network based cost model is to be latency optimized, wherein the hardware efficiency estimate is to include a hardware utilization prediction, and wherein the instructions, when executed, further cause the processor to generate one or more of a compiler decision, a driver decision or a network architecture search decision based on the hardware efficiency estimate.

Example 6 includes at least one computer readable storage medium comprising a set of instructions, which when executed by a computing system, cause the computing system to determine a complexity of a task associated with a neural network workload, and generate a hardware efficiency estimate for the task, wherein the hardware efficiency estimate is generated via a neural network based cost model if the complexity exceeds a threshold, and wherein the hardware efficiency estimate is generated via a cost function if the complexity does not exceed the threshold.

Example 7 includes the at least one computer readable storage medium of Example 6, wherein the instructions, when executed, further cause the computing system to train the neural network based cost model based on one or more of hardware profile data or register-transfer level data.

Example 8 includes the at least one computer readable storage medium of any one of Examples 6 to 7, wherein the neural network based cost model is to be accuracy optimized, wherein the hardware efficiency estimate is to include a vector that embeds the task into an abstract embedding space, and wherein the instructions, when executed, further cause the computing system to fetch a database entry based on the vector.

Example 9 includes the at least one computer readable storage medium of Example 8, wherein the instructions, when executed, further cause the computing system to generate one or more of a dynamic voltage and frequency scaling decision or a key performance indicator decision based on the hardware efficiency estimate.

Example 10 includes the at least one computer readable storage medium of any one of Examples 6 to 7, wherein the neural network based cost model is to be latency optimized, and wherein the hardware efficiency estimate is to include a hardware utilization prediction.

Example 11 includes the at least one computer readable storage medium of Example 10, wherein the instructions, when executed, further cause the computing system to generate one or more of a compiler decision, a driver decision or a network architecture search decision based on the hardware efficiency estimate.

Example 12 includes the at least one computer readable storage medium of Example 6, wherein the cost function is to generate the hardware efficiency estimate independently of second order effects and nonlinearities associated with the task.

Example 13 includes a semiconductor apparatus comprising one or more substrates, and logic coupled to the one or more substrates, wherein the logic is implemented at least partly in one or more of configurable or fixed-functionality hardware, the logic to determine a complexity of a task associated with a neural network workload, and generate a hardware efficiency estimate for the task, wherein the hardware efficiency estimate is generated via a neural network based cost model if the complexity exceeds a threshold, and wherein the hardware efficiency estimate is generated via a cost function if the complexity does not exceed the threshold.

Example 14 includes the semiconductor apparatus of Example 13, wherein the logic is further to train the neural network based cost model based on one or more of hardware profile data or register-transfer level data.

Example 15 includes the semiconductor apparatus of any one of Examples 13 to 14, wherein the neural network based cost model is to be accuracy optimized, wherein the hardware efficiency estimate is to include a vector that embeds the task into an abstract embedding space, and wherein the logic is further to fetch a database entry based on the vector.

Example 16 includes the semiconductor apparatus of Example 15, wherein the logic is further to generate one or more of a dynamic voltage and frequency scaling decision or a key performance indicator decision based on the hardware efficiency estimate.

Example 17 includes the semiconductor apparatus of any one of Examples 13 to 14, wherein the neural network based cost model is to be latency optimized, and wherein the hardware efficiency estimate is to include a hardware utilization prediction.

Example 18 includes the semiconductor apparatus of Example 17, wherein the logic is further to generate one or more of a compiler decision, a driver decision or a network architecture search decision based on the hardware efficiency estimate.

Example 19 includes the semiconductor apparatus of Example 13, wherein the cost function is to generate the hardware efficiency estimate independently of second order effects and nonlinearities associated with the task.

Example 20 includes the semiconductor apparatus of Example 13, wherein the logic coupled to the one or more substrates includes transistor channel regions that are positioned within the one or more substrates.

Example 21 includes a method of operating a performance-enhanced computing system, the method comprising determining a complexity of a task associated with a neural network workload, and generating a hardware efficiency estimate for the task, wherein the hardware efficiency estimate is generated via a neural network based cost model if the complexity exceeds a threshold, and wherein the hardware efficiency estimate is generated via a cost function if the complexity does not exceed the threshold.

Example 22 includes the method of Example 21, further including training the neural network based cost model based on one or more of hardware profile data or register-transfer level data.

Example 23 includes the method of any one of Examples 21 to 22, wherein the neural network based cost model is accuracy optimized, and wherein the hardware efficiency estimate includes a vector that embeds the task into an abstract embedding space, the method further including fetching a database entry based on the vector.

Example 24 includes the method of Example 23, further including generating one or more of a dynamic voltage and frequency scaling decision or a key performance indicator decision based on the hardware efficiency estimate.

Example 25 includes the method of any one of Examples 21 to 22, wherein the neural network based cost model is latency optimized, and wherein the hardware efficiency estimate includes a hardware utilization prediction, the method further including generating one or more of a compiler decision, a driver decision or a network architecture search decision based on the hardware efficiency estimate.

Example 26 includes an apparatus comprising means for performing the method of any one of Examples 21 to 25.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller;
a processor coupled to the network controller; and
a memory coupled to the processor, the memory including a set of instructions, which when executed by the processor, cause the processor to:
determine a complexity of a task associated with a neural network workload, and
generate a hardware efficiency estimate for the task, wherein the hardware efficiency estimate is generated via a neural network based cost model if the complexity exceeds a threshold, and wherein the hardware efficiency estimate is generated via a cost function if the complexity does not exceed the threshold.

2. The computing system of claim 1, wherein the instructions, when executed, further cause the processor to train the neural network based cost model based on one or more of hardware profile data or register-transfer level data.

3. The computing system of claim 1, wherein the neural network based cost model is to be accuracy optimized, wherein the hardware efficiency estimate is to include a vector that embeds the task into an abstract embedding space, and wherein the instructions, when executed, further cause the processor to fetch a database entry based on the vector.

4. The computing system of claim 3, wherein the instructions, when executed, further cause the processor to generate one or more of a dynamic voltage and frequency scaling decision or a key performance indicator decision based on the hardware efficiency estimate.

5. The computing system of claim 1, wherein the neural network based cost model is to be latency optimized, wherein the hardware efficiency estimate is to include a hardware utilization prediction, and wherein the instructions, when executed, further cause the processor to generate one or more of a compiler decision, a driver decision or a network architecture search decision based on the hardware efficiency estimate.

6. At least one computer readable storage medium comprising a set of instructions, which when executed by a computing system, cause the computing system to:
determine a complexity of a task associated with a neural network workload; and
generate a hardware efficiency estimate for the task, wherein the hardware efficiency estimate is generated via a neural network based cost model if the complexity exceeds a threshold, and wherein the hardware efficiency estimate is generated via a cost function if the complexity does not exceed the threshold.

7. The at least one computer readable storage medium of claim 6, wherein the instructions, when executed, further cause the computing system to train the neural network based cost model based on one or more of hardware profile data or register-transfer level data.

8. The at least one computer readable storage medium of claim 6, wherein the neural network based cost model is to be accuracy optimized, wherein the hardware efficiency estimate is to include a vector that embeds the task into an abstract embedding space, and wherein the instructions, when executed, further cause the computing system to fetch a database entry based on the vector.

9. The at least one computer readable storage medium of claim 8, wherein the instructions, when executed, further cause the computing system to generate one or more of a dynamic voltage and frequency scaling decision or a key performance indicator decision based on the hardware efficiency estimate.

10. The at least one computer readable storage medium of claim 6, wherein the neural network based cost model is to be latency optimized, and wherein the hardware efficiency estimate is to include a hardware utilization prediction.

11. The at least one computer readable storage medium of claim 10, wherein the instructions, when executed, further cause the computing system to generate one or more of a compiler decision, a driver decision or a network architecture search decision based on the hardware efficiency estimate.

12. The at least one computer readable storage medium of claim 6, wherein the cost function is to generate the hardware efficiency estimate independently of second order effects and nonlinearities associated with the task.

13. A semiconductor apparatus comprising:
one or more substrates; and
logic coupled to the one or more substrates, wherein the logic is implemented at least partly in one or more of configurable or fixed-functionality hardware, the logic to:
determine a complexity of a task associated with a neural network workload; and
generate a hardware efficiency estimate for the task, wherein the hardware efficiency estimate is generated via a neural network based cost model if the complexity exceeds a threshold, and wherein the hardware efficiency estimate is generated via a cost function if the complexity does not exceed the threshold.

14. The semiconductor apparatus of claim 13, wherein the logic is further to train the neural network based cost model based on one or more of hardware profile data or register-transfer level data.

15. The semiconductor apparatus of claim 13, wherein the neural network based cost model is to be accuracy optimized, wherein the hardware efficiency estimate is to include a vector that embeds the task into an abstract embedding space, and wherein the logic is further to fetch a database entry based on the vector.

16. The semiconductor apparatus of claim 15, wherein the logic is further to generate one or more of a dynamic voltage and frequency scaling decision or a key performance indicator decision based on the hardware efficiency estimate.

17. The semiconductor apparatus of claim 13, wherein the neural network based cost model is to be latency optimized, and wherein the hardware efficiency estimate is to include a hardware utilization prediction.

18. The semiconductor apparatus of claim 17, wherein the logic is further to generate one or more of a compiler decision, a driver decision or a network architecture search decision based on the hardware efficiency estimate.

19. The semiconductor apparatus of claim 13, wherein the cost function is to generate the hardware efficiency estimate independently of second order effects and nonlinearities associated with the task.

20. The semiconductor apparatus of claim 13, wherein the logic coupled to the one or more substrates includes transistor channel regions that are positioned within the one or more substrates.

21. A method comprising:
determining a complexity of a task associated with a neural network workload; and
generating a hardware efficiency estimate for the task, wherein the hardware efficiency estimate is generated via a neural network based cost model if the complexity exceeds a threshold, and wherein the hardware efficiency estimate is generated via a cost function if the complexity does not exceed the threshold.

22. The method of claim 21, further including training the neural network based cost model based on one or more of hardware profile data or register-transfer level data.

23. The method of claim 21, wherein the neural network based cost model is accuracy optimized, and wherein the hardware efficiency estimate includes a vector that embeds the task into an abstract embedding space, the method further including fetching a database entry based on the vector.

24. The method of claim 23, further including generating one or more of a dynamic voltage and frequency scaling decision or a key performance indicator decision based on the hardware efficiency estimate.

25. The method of claim 21, wherein the neural network based cost model is latency optimized, and wherein the hardware efficiency estimate includes a hardware utilization prediction, the method further including generating one or more of a compiler decision, a driver decision or a network architecture search decision based on the hardware efficiency estimate.
